(19) United States
(12) Patent Application Publication
(10) Pub. No.: US 2023/0058955 A1
(43) Pub. Date: Feb. 23, 2023

(54) HYBRID HNB AND E-CIG DEVICE

(71) Applicant: Altria Client Services, Richmond, VA (US)

(72) Inventors: Ryan SELBY, Vancouver (CA); Ryan KARKAIRAN, Vancouver (CA)

(73) Assignee: Altria Client Services LLC, Richmond, VA (US)

(21) Appl. No.: 17/794,642

(22) PCT Filed: Jan. 15, 2021
(86) PCT No.: PCT/CA2021/000004

§ 371 Date: Jul. 22, 2022

Related U.S. Application Data
(60) Provisional application No. 62/961,763, filed on Jan. 16, 2020.

(51) Int. Cl. A24F 40/30; A24F 40/20; A24F 40/10; A24F 7/00; A24F 40/485; A24F 40/57; A24D 1/20

(52) U.S. Cl. CPC A24F 40/30; A24F 40/20; A24F 40/10; A24F 7/00; A24F 40/485; A24F 40/57; A24D 1/20

(57) ABSTRACT

A hybrid aerosol-generating device contains a HNB article and an ECIG article. The hybrid aerosol-generating device allows for simultaneous inhalation from both a HNB article and an ECIG article. The hybrid device includes a HNB article configured to heat non-liquid materials without combustion of the non-liquid materials and also includes an ECIG article configured to heat liquid materials without combustion of the liquid materials. The hybrid aerosol-generating device may further include a mouthpiece connected to both the HNB article and the ECIG article to allow for the simultaneous delivery of aerosols and/or vapors created by the heated non-liquid materials and the heated liquid materials.

### CROSS-REFERENCE TO RELATED APPLICATIONS

The present application is a national phase entry of International Application No. PCT/CA2021/000004, filed Jan. 15, 2021, which claims priority to U.S. Provisional No. 62/961,763, filed Jan. 16, 2020, the entire contents of each of which are incorporated herein by reference.

### TECHNICAL FIELD

The present disclosure relates generally to alternatives to traditional cigarettes. More particularly the present device relates to heat-not-burn devices (“HNB”) and electronic cigarette devices (“ECIG”). Even more particularly, the present disclosure relates to a more robust and more flavorful alternative cigarette system which is a hybrid or combination of HNB and ECIG devices.

### BACKGROUND

Battery operated smoking apparatus or electronic cigarettes, e-cigs or vaporizers, (“ECIG Systems”) were designed as a healthier alternative to smoking traditional cigarettes, which by vaporizing a liquid produce less smell and may produce fewer harmful toxins and particulate matter. A variety of flavors are available with ECIG Systems, and ECIG Systems can be efficient in use, as the number of “hits” or draws on an ECIG System is limited only by the size of the liquid reservoir. They have disadvantages, however, including an inferior: flavor; taste; mouth feel; and throat hit.

Heat-not-burn devices or heated tobacco devices or heated cigarette devices (“HNB Systems”) are another alternative to traditional cigarettes and heat real tobacco or other non-liquid materials without initiating combustion, thereby avoiding carbon monoxide and potentially avoiding the production of harmful chemicals and byproducts of combustion. HNB Systems produce emissions in the form of vapor or aerosols, not smoke, thereby avoiding the smell of traditional cigarettes as well. Because there is no combustion, there is no ash - one may simply permit the heated material to cool down. HNB vapors or aerosols may contain less carcinogens than traditional cigarettes, but may still contain tobacco flavors and nicotine. They have disadvantages, however, often including an inferior: flavor; taste; vapor production; and slow heat-up times. A variety of flavors are available with HNB Systems. The use of the HNB Systems is not unlimited—they are rather a single-use system in which the component of the HNB System which contains the non-liquid aerosol-generating materials must be replaced after a few minutes of use.

There is, therefore, a need for a system (the “hybrid aerosol generating device”) which provides the advantages provided by ECIG Systems and HNB Systems over traditional cigarettes, without the disadvantages provided by the independent use of either ECIG Systems or HNB Systems.

### SUMMARY

A hybrid smoker's article is provided which combines an ECIG and HNB system to obtain several advantages in efficiency, clean operation, and advantageous mouth feel and taste.

A cassette style HNB device is also provided, which rapidly releases a large volume of vapour, using a high speed feed system and advantageous heater arrangement.

### BRIEF DESCRIPTION OF THE DRAWINGS

The above, and other, aspects, features, and advantages of several embodiments of the present disclosure will be more apparent from the following Detailed Description as presented in conjunction with the following several figures of the Drawings.

The apparatus and methods of the present disclosure will now be described with reference to the several accompanying figures of the Drawings, as follows.

FIG. 1 is a side view of a side-by-side configuration of a hybrid aerosol generating device where the case is transparent, in accordance with an embodiment of the present disclosure.

FIG. 2 is a top plan view of a side-by-side configuration of a hybrid aerosol generating device, in accordance with an embodiment of the present disclosure.

FIG. 3 is a side view of a side-by-side configuration of a hybrid aerosol generating device where the case is transparent with a single mouthpiece, in accordance with an embodiment of the present disclosure.

FIG. 4 is a side view of a hybrid aerosol generating device where the case is transparent, showing an ECIG Pod having a mouthpiece which covers or surrounds the

HNB Stick, in accordance with an embodiment of the present disclosure.

FIG. 5 is a side view of a hybrid aerosol generating device where the case is transparent, HNB Stick having a mouthpiece which covers or surrounds the ECIG Pod, in accordance with an embodiment of the present disclosure.

FIG. 6 is a side view of a hybrid aerosol generating device where the case is transparent, having an ECIG Pod constructed in a donut shape which surrounds the HNB Stick, said ECIG Pod and HNB Stick each having a mouthpiece, in accordance with an embodiment of the present disclosure.

FIG. 7 is a side view of a hybrid aerosol generating device where the case is transparent, with a parallel configuration in which the airflow exiting the ECIG Pod is merged into the side of the HNB Stick, said HNB stick having a mouthpiece, in accordance with an embodiment of the present disclosure.

FIG. 8 is a side view of a hybrid aerosol generating device where the case is transparent, with an inline configuration in which the ECIG Pod is located at the bottom end of the HNB Stick, said HNB Stick having a mouthpiece, in accordance with an embodiment of the present disclosure.

FIG. 9 is a side view of a hybrid aerosol generating device where the case is transparent, with a reversed inline configuration in which the HNB Stick is located at the bottom end of the ECIG pod, said ECIG pod having a mouthpiece, in accordance with an embodiment of the present disclosure.

FIG. 10 is a side view of a hybrid aerosol generating device where the case is transparent, with an offset configuration in which the HNB Stick is located adjacent or proximal to the bottom end of the ECIG Pod, said ECIG Pod having a mouthpiece and an opening on the side of the ECIG Pod to permit the ECIG Pod to interface with the top end of the HNB Stick, thereby merging the airstreams from both the HNB Stick and the ECIG Pod into a single airstream, in accordance with an embodiment of the present disclosure.

FIG. 11 is a side view of a hybrid aerosol generating device where the case is transparent, with a barrel magazine HNB Stick configuration in which multiple HNB Sticks may be loaded into the hybrid aerosol generating device, said barrel magazine being located at or proximal to the bottom end of the ECIG Pod, and said ECIG Pod having a mouthpiece, in accordance with an embodiment of the present disclosure.

FIG. 12 is a bottom end view of a hybrid aerosol generating device where the case is transparent, with a barrel magazine HNB Stick configuration, in accordance with an embodiment of the present disclosure.

FIG. 13 is a side view of a hybrid aerosol generating device where the case is transparent, with a sectional HNB Stick showing multiple heaters capable of heating discrete sections or regions of the HNB Stick, said sectional HNB Stick being located at or proximal or adjacent to the bottom end of the ECIG Pod, and a dual mouthpiece configuration in which both the sectional HNB Stick and the ECIG Pod each have their own mouthpieces, in accordance with an embodiment of the present disclosure.

FIG. 14 is a side view of a hybrid aerosol generating device where the case is transparent, in which a barrel magazine HNB Stick configuration is located at the bottom end of a ECIG Pod, with the barrel magazine HNB Stick configuration fluidly connected to the bottom of the ECIG Pod, said ECIG Pod having a mouthpiece, in accordance with an embodiment of the present disclosure.

FIG. 15 is an end view of a barrel magazine HNB stick configuration, in accordance with an embodiment of the present disclosure.

FIG. 16 is a diagrammatic view of a reel-to-reel HNB Stick configuration showing a cassette reel-to-reel configuration holding a ribbon or tape made from non-liquid aerosol-generating material, with said material being passed through a dual heater, in accordance with an embodiment of the present disclosure.

FIG. 17 is a side view of a hybrid aerosol generating device where the case is transparent, with a Hybrid Aerosol-Generating pod containing a mouthpiece, the components of an ECIG Pod, a reel-to-reel HNB Stick configuration, and an airflow path originating from outside of the hybrid aerosol generating device and exiting through the mouthpiece of the Hybrid Aerosol-Generating pod in accordance with an embodiment of the present disclosure.

FIG. 18 is a side view of an ECIG Pod where the case is transparent, showing an ECIG Pod with a mouthpiece and a configuration for receiving the top end of an HNB Stick, in accordance with an embodiment of the present disclosure.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood, elements that are useful or necessary in commercially feasible embodiments are often not depicted in order to facilitate a less obstructed view of these various embodiments of the present disclosure.

### DETAILED DESCRIPTION

The following description is not to be taken in a limiting sense but is made merely for the purpose of describing the general principles of exemplary embodiments. The scope of the disclosure should be determined with reference to the Claims. Reference throughout this specification to “one embodiment,” “an embodiment,” or similar language that denotes a particular feature, structure, or characteristic, described in connection with the embodiment, is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description numerous specific details are provided for a thorough understanding of embodiments of the disclosure. One skilled in the relevant art will recognize, however, that the embodiments of the present disclosure can be practiced without one or more of the specific details, or with other methods, components, materials, and so forth, and still remain encompassed by the present disclosure. In other instances, well-known structures, materials, or operations are not shown or described in detail to avoid obscuring aspects of the present disclosure.

The e-cig, electronic cigarette device or electronic cigarettes or vaporizers (“ECIG Systems” or “EGIC”) employed in the present invention may comprise the following components: a vaporizing chamber; a heating element, or atomizer, for converting liquid materials into aerosols or vapors; wires or other connections for electronically connecting the vaporizing chamber, heating element, or atomizer to a power source; a liquid reservoir for containing liquid nicotine and or other liquid materials such as propylene glycol, glycerin, and flavorings; a wick or other similar structure for conveying the liquid material from the liquid reservoir to the vaporizing chamber, heating element, or atomizer; and at least one airflow pathway which permits air to be drawn through the vaporizing chamber, heating element, or atomizer and out through a mouthpiece into an adult user's mouth; all contained within a casing or pod. The pod may be connected to a power source such as a rechargeable, usually lithium, battery. The pods may be removeable and disposable, and the ECIG battery may be chargeable by any known means, often by a USB port, all of which may be done while a part of, without dismantling, the hybrid systems of this disclosure.

Generally, existing ECIG Systems may consist of two main components: the pod component (“ECIG Pod”) which contains the vaporizing chamber or heating element or atomizer, a liquid reservoir, liquid material or materials, a wick or similar structure, and an airflow pathway; and a power supply component (“ECIG Battery”) which may contain a rechargeable lithium battery, a power control system, and an apparatus or charging port for recharging the power supply or battery. The ECIG Pod may be a multiple use component which can be used multiple times until the liquid contained in the liquid reservoir contained within the ECIG Pod is depleted. When the liquid is depleted, the ECIG Pod can either be discarded, or in some embodiments, the liquid can be refilled in the liquid reservoir within the ECIG Pod, and then the ECIG Pod can continue to be used, until the liquid is, again, depleted.

HNB Systems employed may be of any standard type, including an embedded heat source, external heat source, or a heat-sealed chamber. The heater may introduce thermal energy to the aerosol-generating material either through conductive heat transfer, convective heat transfer, or radiative heat transfer. The heater may be heated using electrical resistance heating, induction heating, thermochemical heating, combustive heating, friction heating, or any other known method for generating thermal energy in the heater. The HNB System may be powered by a rechargeable lithium battery which is typically contained within a housing which also contains the heater.

Generally, existing HNB Systems consist of two main components: the cigarette component (“HNB Stick”); which consists of a wrapper or other enclosure containing the non-liquid aerosol-generating material, an airflow pathway, and often a filter or series of filters; and the power supply component (“HNB Heating Device”) which may contain at least one heater, a lithium battery, some form of power control system, and some apparatus or charging port for recharging the battery. The HNB Stick may be a single-use component which can be used for a limited duration before being discarded and replaced with a new HNB Stick prior to a subsequent use of the HNB Heating Device.

The HNB Systems of the present invention may be of any known type and incorporate the standard main components, including systems which: heat processed tobacco or reconstituted tobacco sheets (usually including humectants such as water and glycerin) to generate an aerosol emission; use processed tobacco which is heated in order to release an aerosol; employ an aerosol which passes over and or through processed and or reconstituted tobacco; heat loose-leaf tobacco; or which heat a traditional cigarette.

The present hybrid aerosol generating embodiments provide numerous benefits to a user beyond those benefits which can be obtained by a user from the use of either an ECIG System or an HNB System individually. In operation, a user places his or her mouth on the mouthpiece and inhales and will receive a draw or hit from both the HNB Stick and ECIG Pod at the same time. An embodiment of the present invention is electrically connecting both a HNB device and an ECIG device. This results in receiving a draw of a mixture or combination comprised of both the vapors and aerosols, or inhalable emissions, produced by the heating of the liquid of any desired flavor in the ECIG Pod, with the vapors and aerosols or inhalable emissions, produced by the heating of the non-liquid materials in the HNB Stick, which, being delivered to the user at the same time, provide a closer to traditional smoking taste and feel, creating an optimal smoking experience, while likely reducing the negative health effects of traditional smoking. The advantages of this system, over smoking, created by avoiding combustion, apply for any material capable of generating an aerosol when sufficiently heated, as it is primarily the carbon monoxide and particulate matter byproducts of combustion which are carcinogenic, and this is generally the case with any combusted material.

Benefits of the hybrid aerosol generating device include the resulting mouth and throat hit, feel and taste, provided to the user, due to the combination of the two types of devices, HNB and ECIG. Known ECIG Systems vaporize a liquid, resulting in aerosolized nicotine and optionally, flavor, while potentially avoiding some of the harmful chemicals and by-products received by the user when smoking traditional cigarettes, such as particulate matter, carbon monoxide and tar. This is also called vaping. A challenge with vaping or e-cig use is that the resulting emissions in the form of mist or vapor, while delivering nicotine and flavor without a high level of particulate matter and some other undesirable chemicals, do not provide a mouth feel or throat hit which for users is adequately comparable to smoking. Mouth feel has also been described as a fundamental sensory attribute, which combines with taste and smell, and determines the overall flavor or experience to the user from the material being consumed, whether solid, liquid or gas. The throat hit is a sensation imparted by combusted or heated material passing down the user's throat, and may be affected by the level of nicotine, power or temperature of the vapor, presence of menthol or citrus or other flavors, and airflow volume and speed. The present hybrid aerosol generating device invention permits not only an optimal mixing of mouth feel and throat hit with cleanly vaporized nicotine and flavors, but also permits adjustment by the user to achieve a customized mixing of the vapors and aerosols produced by both the ECIG Pod and HNB Stick. This customization can be achieved by a user either electronically or mechanically manipulating a valve by an adjustment means on either the device or the mouthpiece, and or such customization may be achieved by electronic, manual, or automatic adjustments being made to the heating parameters of one or more of the heaters or other aerosol generating features. Additionally, embodiments of the present invention enable multiple re-uses, without onerous cleaning requirements. Present HNB Systems have onerous cleaning requirements, ideally after every use, and the quality of fumes, draw or the output of known devices diminishes sharply when not regularly and constantly cleaned.

An embodiment of the present invention permits retrofitting of an ECIG System into a base or module which also accepts a HNB System. By permitting simultaneous access to the mouthpieces of the two devices by the user, or by providing a rerouting of the flow of at least one of the HNB Stick emission or ECIG Pod emission, or a dual mouthpiece with a chamber that collects the output from both devices, the present hybrid aerosol generating device invention permits the user to concurrently use both devices in an optimal manner. Liquid aerosol generating materials include but are not limited to vegetable glycerin, propylene glycol, water, polyethylene glycol, dipropylene glycol, higher molecular weight linear polyesterdiols, e-cigarette fluids, e-juice, hydrophilic solvents, or any combination of the previously listed liquid materials, or other combinations of liquid or non-liquid material(s) such that they are in a liquid form, or any of the previously listed material(s) or other liquid material(s) which are combined with non-liquid aerosol generating materials, and or any combustible plant or other liquid or non-liquid material(s) the emissions of which a human can inhale. Non-liquid aerosol generating materials include but are not limited to tobacco(s), reconstituted tobacco(s), paper(s), plant material(s), substrate(s), wicking material(s), natural or manmade fiber(s), or any combination of the previously listed non-liquid materials, or other combinations of liquid an or non-liquid materials such that the resulting material is in a non-liquid form, or any of the previously listed non-liquid material(s) or other non-liquid material(s) which are saturated with any liquid aerosol generating material(s) such that the resulting combination of materials is in a non-liquid form, and any combustible plant or other non-liquid material(s) the emissions of which a human can inhale.

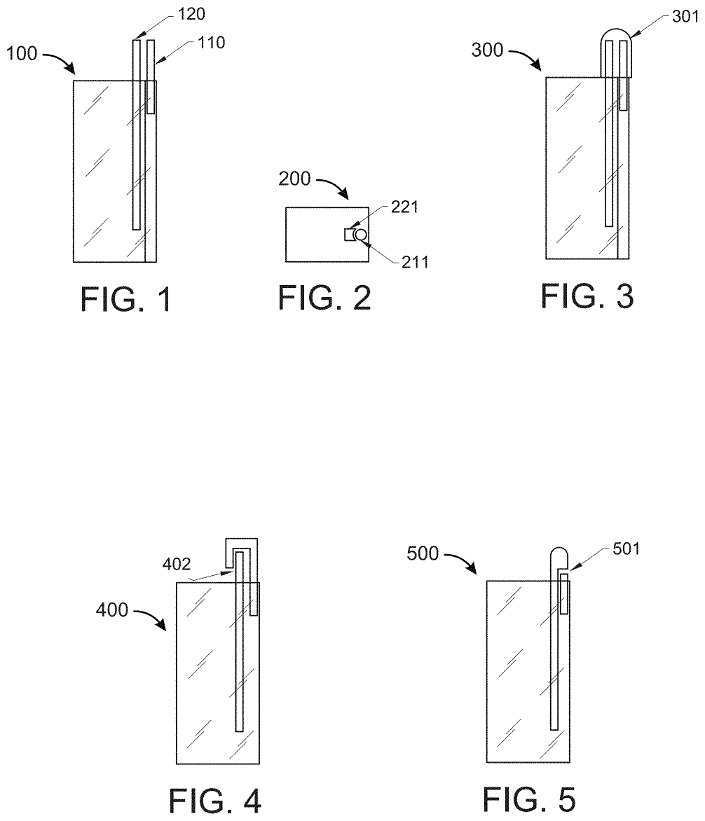

Referring to FIG. 1, this sketch illustrates, in a front elevation perspective view, a hybrid aerosol generating device 100, in accordance with an embodiment of the present disclosure. The hybrid aerosol generating device 100 incorporates the standard main components of both an ECIG Battery and an HNB Heating Device, and additionally the hybrid aerosol generating device 100 is designed to work with an HNB Stick 120 containing the standard components of an HNB Stick and an ECIG Pod 110 containing the standard components of an ECIG Pod.

Referring to FIG. 3, this sketch illustrates, in a front elevation perspective view, a hybrid aerosol generating device with a single, removable mouthpiece, ideally comprised of plastic for ease of fit and mouth feel. The mouthpiece abuts, accommodates, encompasses, or surrounds the mouthpieces of the ECIG Pod and the HNB Stick in a single chamber. The HNB Stick and ECIG Pod may be housed in a single chamber, but in an embodiment, are simply two separate, independently operable devices which the user plugs into a base, ideally of plastic and sized to accept the particular models of HNB System and ECIG System, then the user snaps or locates the plastic mouthpiece over the mouthpieces of the two devices. An elastic retainer may be added to the upper portion, proximal to the mouthpiece in order to retain and stabilize the two devices together. In an embodiment, the base may incorporate electronic connections to permit charging of the devices while installed in the base. In an embodiment, the base may be a case which surrounds, or substantially surrounds, or entirely encompasses one or more of the independently operable HNB and ECIG devices. In an embodiment, the case may have a removable mouthpiece. In an embodiment, the case may include an independent battery which is capable of charging one or more of the HNB and or ECIG devices.

In another embodiment, the base may include a rechargeable battery to charge the devices when installed in the base. In another embodiment, the base may provide charging to both devices via one connection to an external power source. In another embodiment, the mouthpiece may include a baffle or other similar structure to permit the user to vary the amount of vapor flow from each device (i.e., 70% HNB and 30% ECIG).

In another embodiment the mouthpiece may include one or more vents (which may be optionally closable or adjustable by the user) to permit external air flow to mix with the vapor stream.

FIG. 2 shows a top view of a hybrid aerosol generating device 200 with side-by-side mouthpieces of the HNB Stick 211 and the ECIG Pod 221, such that a user can draw on both simultaneously.

FIG. 3 depicts an embodiment of a hybrid aerosol generating device 300 with a single mouthpiece 301, optimally comprised of plastic, although other materials may be used, with the heating of the liquid material contained in the ECIG Pod and the heating of the non-liquid material contained in the HNB Stick occurring in parallel, providing the most efficient mixing of the vapor. The mouthpiece 301 optimally has rounded edges for the comfort of the user, and is optimally removable, to permit cleaning or replacement (even temporary, for health and safety reasons, so multiple users can attach their own mouthpieces to thereby safely share a single device among multiple users).

FIG. 4 depicts a side-by-side configuration of a hybrid aerosol generating device 400 of the HNB Stick and ECIG Pod, with the ECIG pod being constructed with a mouthpiece that delivers the vapors and aerosols created by the ECIG Pod, and additionally surrounds or encompasses 402 the air outflow of the HNB Stick in order to combine the vapors and aerosols from both the HNB Stick and the ECIG Pod into a unified airstream.

FIG. 5 depicts a side-by-side configuration of a hybrid aerosol generating device 500 of the HNB Stick and ECIG Pod, with the HNB Stick being constructed with a mouthpiece that delivers the vapors and aerosols from the HNB Stick, and additionally surrounds or encompasses 501 the air outflow of the ECIG Pod in order to combine the vapors and aerosols from both the HNB Stick and the ECIG Pod into a unified airstream.

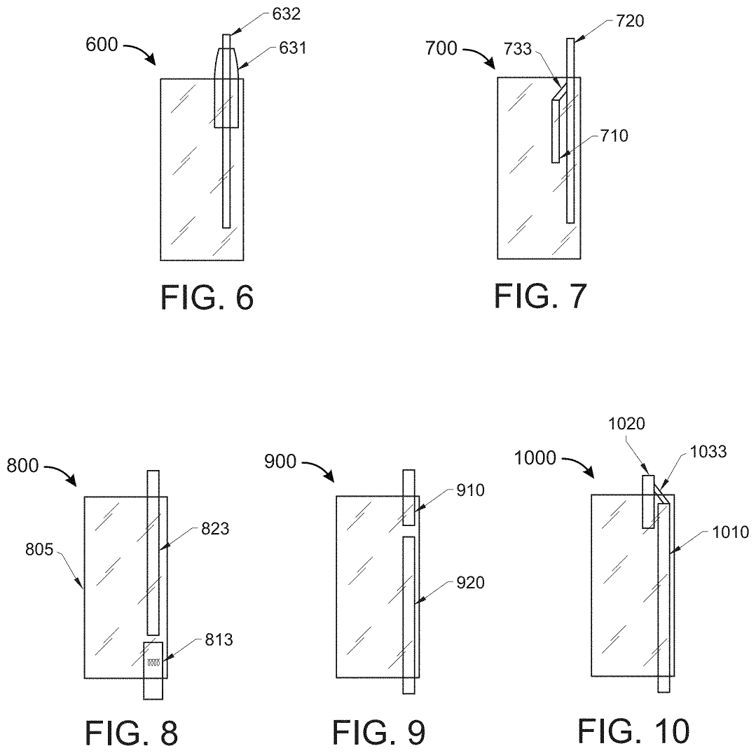

FIG. 6 depicts a configuration of a hybrid aerosol generating device 600 with a donut or toroidal shaped ECIG Pod 631, which radially surrounds the HNB Stick 632 thereby permitting the HNB Stick to pass through the center (or substantially the center) of the ECIG Pod, whereby permitting the vapors and aerosols produced by both the HNB Stick and the ECIG Stick to be combined in an adult user's mouth. The generally donut shaped ECIG Pod 631 and generally cylindrical HNB Stick 632 are optimally separately removable and replaceable.

In an embodiment, a single heating element may then be employed, as the operating temperature for both HNB Stick and the ECIG Pod is optimally in the range of 150-350 degrees Celsius, although the optimal temperature for an HNB tobacco product is at the higher end of that range, typically 200-350 degrees Celsius. The reason these temperatures are optimal for the creation of aerosols and vapors from non-liquid aerosol-generating materials is that temperatures below 200 degrees Celsius are generally not hot enough to release sufficient quantities of vapors and aerosols from non-liquid aerosol-generating materials, and temperatures higher than 350 degrees Celsius tend to induce pyrolysis or combustion in the non-liquid aerosol-generating materials which eliminates many of the benefits obtained from the use of a HNB System over traditional smoking.

In a further embodiment, the e-juice pod/cartridge is constructed in a toroidal or doughnut shaped pod/cartridge which surrounds the HNB stick, permitting the HNB stick to be inserted through the middle of the e-cig pod/cartridge. In this manner, the e-cig/pod cartridge functions as the dual mouthpiece. In a further embodiment, the e-cig pod is constructed with a shape that permits the HNB cigarette to nest adjacent to the e-cig pod, thereby allowing the e-cig pod and the HNB cigarette to be simultaneously placed in a user's mouth allowing the user to inhale from the e-cig pod and the HNB cigarette simultaneously. In another embodiment, the HNB cigarette is constructed so that the HNB cigarette nests adjacent to the e-cig pod. (I.e., either the e-cig pod or the HNB cigarette can be designed to work with each other, or they can both be adapted to work together by adapting the mouthpieces of either the HNB cigarette or the e-cig pod or both by shaping the mouthpieces of either or both such that they are capable of nesting together or fitting closely together).

FIG. 7 depicts an embodiment of a hybrid aerosol generating device 700 with a side-by-side configuration of an HNB Stick 720 and ECIG Pod 710, where a substantially transverse conduit 733 for the ECIG Pod emissions is provided which merges into the conduit for the substantially inline HNB Stick emission conduit, thereby providing a single mouthpiece for the user. The emissions described herein can be assumed to be inhalable. The mixing of these two streams may be controlled by a PLC and any known valve system, such that a user can select a preferred mixing ratio of the two or more emissions, thereby customizing the nicotine level and throat hit and mouth feel to the taste of the particular user. The computer device can via a programmable logic control determine the flow between the two aerosol sources (HNB Stick and ECIG Pod) and also individually determine the temperatures applied to the HNB Stick and the ECIG Pod and the duration of heating applied to each component.

FIG. 8 depicts an embodiment of a hybrid aerosol generating device 800 in which the hybrid aerosol generating device body 805 contains both a chamber 823 for an HNB Stick to be inserted at one end, and a chamber 813 adapted to house an ECIG Pod at an end distal to that of the HNB Stick, such that the HNB Stick and ECIG Pod are essentially disposed inline. At least one heating element is disposed substantially about the HNB Stick, and another about or within the ECIG Pod. The elements operate to simultaneously and controllably heat the two components and create emissions which flow inline through the hybrid aerosol generating device to the mouth of the user.

FIG. 9 depicts and embodiment of a hybrid aerosol generating device 900 showing the reverse arrangement to FIG. 8, wherein the two heating means are in line, but the ECIG Pod 910 and adjacent or within-contained heater (not shown here) are at the top end of the hybrid aerosol generating device 900 and the HNB Stick 920 is inserted at the distally located bottom, or opposite, end. The airflow flows in through the end of the HNB Stick 920 and through the HNB Stick 920, and subsequently flows into the ECIG Pod 910, mixing the vapors and aerosols into a unified airstream before the vapors and aerosols exit through the mouthpiece end of the ECIG Pod 910. As is known in the art, the draw of air on the mouthpiece by the user may initiate the heating element contained about or within the ECIG Pod and or the HNB Stick.

FIG. 10 depicts an embodiment of a hybrid aerosol generating device which shows a conduit 1033 linking the HNB Stick 1010 to the ECIG Pod 1020 in the hybrid aerosol generating device 1000. In this embodiment, one or more heating elements located about or surrounding the HNB Stick 1010 heat the aerosol-generating non-liquid material contained within the HNB Stick to temperatures between 150-350 degrees Celsius, and the resulting emissions travel through a conduit to merge with the emissions produced in the ECIG Pod 1020 before exiting through the mouthpiece of the ECIG Pod 1020. It takes longer to slowly heat the HNB Stick, so if the user turns on the device and does not want to wait for the HNB Stick to produce vapors or aerosols, he or she can begin by inhaling primarily vapors or aerosols produced by the ECIG Pod until the HNB Stick is sufficiently heated to produce vapors or aerosols.

In an additional embodiment, a barrel cylinder 1150 configuration may be used for receiving a plurality of HNB Sticks. Like a six-shooter revolver pistol, the barrel chamber may be rotated for each HNB Stick use. The plurality of HNB Sticks may be inserted into the plurality of barrel chambers though one or more openings in either the top, bottom, or sides of the barrel chamber, said openings being accessible by an access door, panel, or covering on the Device housing, or by a user manipulating a break-top, swing-out, or insertable cylinder or barrel, said cylinder or barrel being constructed with a plurality of tubes or openings, optimally six, bur other configurations and numbers may be employed, to receive HNB Sticks inserted by a user. The cylinder may be housed adjacent or proximal to at least one air inlet which is capable of delivering an air inflow into the selected HNB Stick, and the cylinder is housed adjacent or proximal to at least one mouthpiece, which permits air to flow through the selected HNB Stick and into an adult user's mouth via a mouthpiece. The mouthpiece component routes vapor from a heating chamber to the mouth of a user. The user can preload a plurality of HNB Sticks into the cylinder and can selectively chose an HNB Stick (either by manually rotating the cylinder (or other similar means) or by electronic means) in order to select a fresh HNB Stick or to select between HNB Sticks of different flavors and varieties.

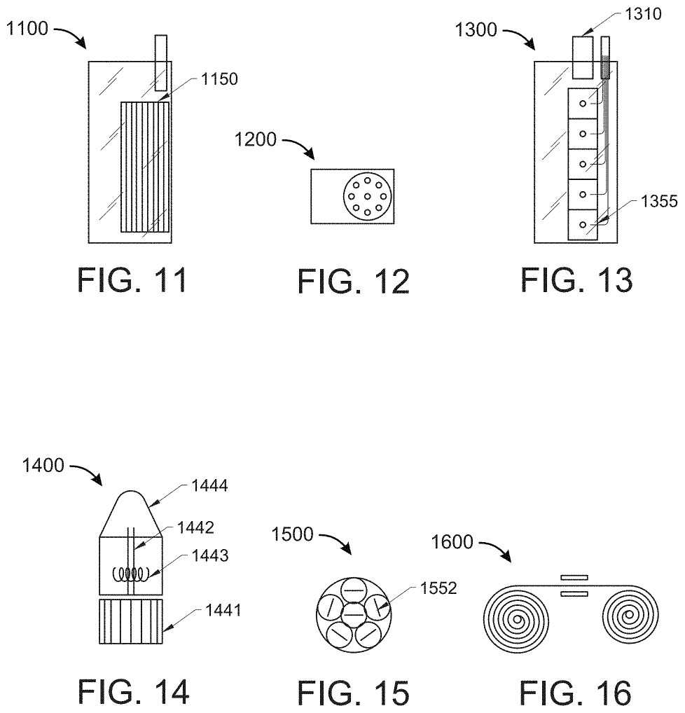

FIG. 11 depicts an embodiment of a hybrid aerosol generating device 1100 with a barrel cylinder 1150 configuration for receiving a plurality of HNB Sticks and an ECIG Pod located adjacent to the barrel cylinder 1150.

In an additional variation, the ECIG Pod is housed in one part of the hybrid aerosol generating device housing, and a single battery is used for both the heating element or atomizer contained within the ECIG Pod, and one or more additional heating elements are located near, adjacent to, or surrounding at least one of more of the barrel cylinder tubes for receiving the HNB Sticks.

FIG. 12 shows the cylinder 1200 from the bottom, in this case with an eight-chamber configuration. Variations in the number of chambers may be employed. In this way, the HNB Stick aspect of the device is more akin to a packet of cigarettes, making use simpler than reloading for every session with the device.

FIG. 13 depicts an inline configuration of a hybrid aerosol generating device 1300 with the ECIG Pod located at a top end of the device 1300 near the mouthpiece and disposed generally below the ECIG Pod 1310 is a chamber 1355 adapted to receive a plurality of HNB sticks which may be constructed in such a form as a string of cubes or other pod shapes containing non-liquid aerosol-generating materials. The chamber may be surrounded by one or more heating elements or coils, and individual HNB Sticks or individual sections of HNB Sticks can be heated sequentially or in any order as controlled by a controlling device such as a programmable logic control, which may, in turn, be controlled by a user. After use, the sectional HNB Sticks which may be in the form of a magazine or strip may be removed and discarded and may be compostable. In operation, when the user turns on the device, the controlling device selects the next available section to heat to the target temperature, optimally 200-350 degrees Celsius so that a sufficient quantity of vapors or aerosols is produced but the material is not combusted, and a vapor and or aerosol emission is released from the particular section, and is drawn by the user down a conduit, which may also initiate heating of the top loaded ECIG Pod which produces a vapor or aerosol which is then mixed with the HNB Stick vapor or aerosol and exits the mouthpiece into the mouth of the user as a combined aerosol having the beneficial characteristics of both streams.

FIG. 14 depicts an embodiment of a hybrid aerosol generating device 1400 with a rotating cylinder 1441 for containing a plurality of HNB Sticks at the base or bottom of the housing with one or more air intakes located at the bottom of the housing, with an ECIG Pod 1442 disposed above and with a heating coil or element 1443 contained within the ECIG Pod. In operation, the draw or suction of the user's breath or inhalation brings ambient air in through the intake valve, through the currently selected HNB Stick where the vapor and or aerosol emission created by the heating of the HNB Stick is then drawn through the aligned ECIG Pod which is heated by a lower coil or heating element. The aerosol emission then drawn through the mouthpiece 1444 into an adult user's mouth.

In another embodiment a stabbing sword heating element may be used in one or more of the HNB Sticks. In an embodiment, FIG. 15 depicts a top view of a cylindrical chamber 1500 for receiving HNB Sticks and containing a plurality of heating elements in the form of blades, stabs, sharp elongated tangs, or projections 1552 each of which functions both to accept an HNB Stick pushed onto and thereby mounted on it as well as functioning to create the vapor or aerosol by heating the HNB Stick from the inside of the HNB Stick. In this manner a plurality of HNB cigarettes can be loaded in a hybrid aerosol generating device then successively heated using a stabbing sword style heating element.

In an embodiment of the present invention, FIG. 16 depicts a side view of a cassette HNB component 1600 (“HNB Cassette”) which can be used in place of the HNB Stick in the hybrid aerosol generating device. A reconstituted tobacco product can be pressed into a strip which is then wound on a reel. In operation, the product rolls from a full reel to an initially empty reel, and in-between, runs through or over or above or under a heating element, at a rate which can be varied and a temperature which can be varied, either by a controller or user or both, thereby producing optimal vapor. The heating element depicted is a double-sided arrangement for optimal performance. An advantage of the HNB Cassette is that a very high temperature (up to an approximate range of 800 degrees Celsius-900 degrees Celsius) can be applied to a thin tape of reconstituted tobacco product which is moving quickly, thereby creating a very fast (less than a second) delivery of emissions or vapors or aerosols, which usually takes approximately 20 to 30 seconds to create in existing HNB Systems, due to the greater mass of the aerosol-generating non-liquid materials. This may be termed flash vaporization. Known or existing HNB Systems are static in method, simply gradually heating an HNB Stick. With the present invention, the user can selectively control the speed of the transfer of the ribbon from one reel to the other reel inside the HNB Cassette and the temperature of the heating element in order to vary the output of the HNB Cassette component. In an embodiment, the ribbon of reconstituted tobacco paper may pass, relatively quickly such as a rate of travel equal or greater than 1 centimeter per second, over a heating element at 800-900 degrees Celsius, which is capable of producing a large volume of vapor. Other embodiments of the HNB Cassette include a ribbon or string or other similar form of non-liquid aerosol-generating material passing through a donut heater or around a heating rod. The ribbon or tape or string may have perforated holes at its edge to receive small pegs on a wheel like a dot matrix printer feeder, and the heater may be disposed in the center of the material between the perforated holes. The ribbon or tape or string may also have strengthening fibers or other features which serve to increase the strength of the ribbon or tape or string in order to prevent inadvertent breakage of the ribbon or tape or string, or to enhance the effectiveness of the transfer of the ribbon or tape or string from one of the reels to the other reel.

In an embodiment, the HNB Cassette employs a strip or ribbon or string or other similar form having a length substantially greater than its diameter or width or thickness, said ribbon being constructed of non-liquid aerosol-generating material, optimally produced from reconstituted tobacco or other suitable non-liquid aerosol-generating material or combinations of materials such as reconstituted tobacco, paper, wicking material, strengthening fibers, or others which are generally consistent in their characteristics, including constituent ingredients, size, porosity, plasticity, homogeneity and malleability, may be used.

In one embodiment of the HNB Cassette, a strip of reconstituted tobacco is wound onto a small reel or other similar structure, and during heating, is dragged over one or more heating elements in the housing of the HNB Cassette at a controlled (and variable at the selection of the user) rate, providing an even heating and airflow, with rapid, smooth and consistent production and delivery of the aerosol or vapor from the heating chamber through the mouthpiece, to the user. The reel-to-reel system of the present invention is also referred to as a cassette system, similar in structure to the cassette tape system which has two reels and a housing which guide magnetic tape from one reel to the other over a magnetic head. In an embodiment of the present invention, the head is, instead, one or more heating elements, which due to the small size requirements of the one or more heating elements, is dramatically reduced in thermal requirements compared to traditional HNB Systems, which has the additional advantage of permitting the HNB Cassette to operate with a single small battery weighing less than 200 grams and having a size smaller than 5 cubic centimeters and operating at a nominal voltage of around 3.6 v and operating at a nominal amperage of around 2 amps, to operate components of the HNB Cassette and additionally reduces the heat-up time that is typically required of all HNB Systems.

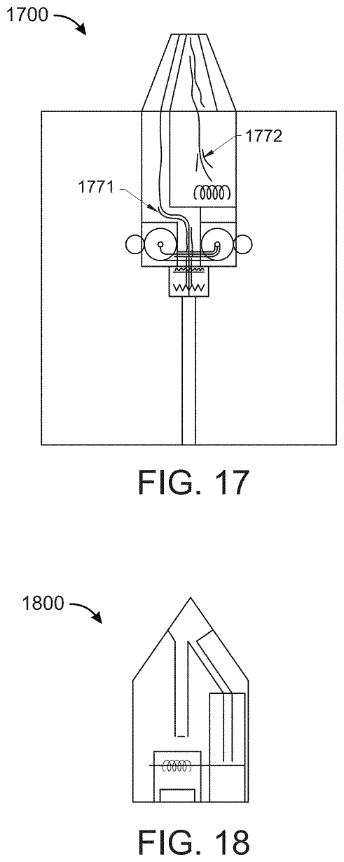

In one embodiment of the hybrid aerosol generating device, the HNB Cassette may be used in conjunction with an ECIG Pod or component. FIG. 17 depicts the body of the hybrid aerosol generating device 1700, and housed within the body of the hybrid aerosol generating device 1700, FIG. 17 depicts a Hybrid Pod (“Hybrid Pod”) containing, in addition to the standard ECIG Pod components, additionally a HNB Cassette capable of generating vapors and aerosols from non-liquid aerosol-generating materials using a reel-to-reel cassette system. In operation, the heating elements of both the HNB Cassette and the ECIG Pod can be triggered by the user drawing air through the Hybrid Pod. Such operation can be affected by any number of known means for detecting a draw from a user, including by use of a microphone sensor which can detect a resulting pressure drop in the Hybrid Pod created by a user drawing on the mouthpiece of the Hybrid Pod, or can be triggered by other known means such as a component for detecting a change in the electrical resistance in one or more of the heating elements contained within the Hybrid Pod. FIG. 17 depicts the Hybrid Pod with a baffle mouthpiece device, where the two aerosols, the vapor and aerosols created by the heating of the ribbon of non-liquid aerosol-generating material in the HNB Cassette component 1771 and the vapors and aerosols generated by the heating of the liquid aerosol-generating materials in the ECIG Pod component 1772, are mixed by a baffle or baffles which may be rotated or adjusted to influence the relative volumes of the emissions created by the two emission sources. The degree of baffle occlusion can be controlled by twisting the mouthpiece or by other known means or valves, which may be done manually or by using a small electric motor or by other electronic control mechanisms. The air inlet on the Hybrid Pod is disposed on the base or bottom or near to it, and the intake air flows over the cassette HNB component as the aerosol is released from the ribbon as the ribbon is passed over the one or more heating elements at a controlled rate, then the resulting emissions enter the mixing chamber formed by the mouthpiece. The emissions created by the heating of the liquid contained within the ECIG Pod component of the Hybrid Pod also simultaneously enters the mixing chamber by separate conduit, at which point the emissions from both the HNB Cassette component and the ECIG Pod component are mixed and unified into a single airstream prior to entering the mouth of an adult user.

In one embodiment, the HNB Cassette may include an ECIG Pod component within the HNB Cassette. In operation, usually the draw or inhaling of the user triggers the heating element in the ECIG Pod component to rapidly heat up and vaporize the e-liquid, while a second heating element abutting the tobacco strip as it reels through it also quickly heats the tobacco to greater than 150 degrees Celsius, and optimally, in the 200-350 degree Celsius range. The ECIG Pod component operates in approximately the 392 degrees Fahrenheit to 480 degrees Fahrenheit (200 degrees Celsius to 250 degrees Celsius) range. This embodiment employs an imbedded heating element for efficiency in the ECIG Pod. The HNB Cassette containing the rolled reconstituted tobacco on one or more reels or other similar structures may hold the equivalent of many single use HNB Sticks, which is advantageous for the convenience of the user, avoiding constant reloading of the device, and may be more environmentally friendly. The ribbon or strip of tobacco may be provided separately to consumers. The HNB Cassette is also advantageous for the user because it permits the near instantaneous generation of aerosols or vapors from non-liquid aerosol-generating materials, such as reconstituted tobacco, compared to the 20-30 second heat up time required by all existing HNB Systems.

In an embodiment, the HNB Cassette may be constructed in a manner similar to the existing audio tape cassette, in which the internal components of the HNB Cassette are contained within an outer case or shell which serves to hold the various components of the HNB Cassette in their required locations. The shell of the HNB Cassette may contain structures for aiding the loading and unloading of the HNB Cassette into a heating device. The HNB Cassette may also have features for assisting with the alignment of the HNB Cassette during loading and unloading from a heating device. The shell of the HNB Cassette may also have air conduits constructed on or within the shell of the HNB Cassette. The shell of the HNB Cassette may also contain an integrated mouthpiece which may or may not be removable.

In another embodiment, a specialized heat device may be employed which is designed to receive the HNB Cassette, said specialized device being configured with one or more heating elements which can contact the ribbon. The specialized device may also contain features such as an openable door or other similar feature (much like a Walkman or portable tape player for audio tapes). The specialized device may also contain features for turning the reels on the HNB Cassette, and for controlling the rate at which the reels are turned. The device may also have a PLC or other control mechanism for controlling the operation of the HNB Cassette, including both the speed that the reels turn, and the temperature of the heating elements. This operation may be achieved electronically or using know mechanical features. The operation of the device can be triggered by a user inhaling on the mouthpiece of the HNB Cassette or can be controlled through a switch or other feature which permits a user to initiate, vary, or stop the heating of the heating element and or the turning of the reels.

In another variation, the ribbon or tape or string is drawn through a reservoir or tank containing liquid material (such as e-liquid), such that the heating of the saturated ribbon gives of a flavorful rich vapor from both the liquid and the heated tobacco simultaneously, in an efficient heating manner. In this way, the ribbon may be saturated with consumables of any type. The e-liquid tank may be contained inside the HNB Cassette assembly or may be contained outside of the HNB Cassette assembly.

The previously described ribbon wick offers a new way of bringing the heating element outside of an ECIG Pod, which allows the ECIG Pod to be more environmentally friendly or even compostable, something that is impossible with current ECIG Pods which contain one or more embedded heating elements inside the ECIG Pod.

FIG. 18 depicts an embodiment of an hybrid aerosol generating device with a side-by-side configuration showing a ECIG Pod 1800 with a mouthpiece, said mouthpiece being configured in such a way as to permit an HNB Stick to be encompassed by the ECIG Pod, so that the emissions from the HNB Stick can be conveyed through a conduit into a chamber in the mouthpiece of the ECIG Pod, where the emissions from both the ECIG Pod and the HNB Stick can be mixed and unified into a single airstream prior to entering the mouth of an adult user.

In another embodiment, the hybrid aerosol generating device may be a case designed to hold or contain within it two or more existing HNB Systems or ECIG Systems, with a mouthpiece to blend the vapor between the two.

In a variation, the hybrid aerosol generating device has a single air inlet, and the air is drawn through both the HNB Stick and the ECIG Pod before being drawn out through the mouthpiece to the user. The air inlet and outlet may be at the same end or located on different parts of the housing.

While there are loose-leaf HNB Systems, and these can be employed in the hybrid aerosol generating device in a variation, there is generally too much variation in the loose-leaf tobacco to deliver a uniform heating and vapor to be efficient.

The present invention provides for a high level of customization by the user. Flavored or unflavored tobacco can be heated at the same time as flavored or unflavored e-juice, and the potency, nicotine and levels of other materials and chemicals may be easily adjusted or selected by the user selecting different e-juices and HNB cigarettes or tobacco strips, to provide different throat hits, flavors, and output such as nicotine levels.

A further advantage of the hybrid aerosol generating device is that it reduces the need for humectants because the humectants are primarily added to the HNB cigarette to increase the visible vapor production or to modify the flavor, and in the hybrid aerosol generating device the ECIG Pod can provide the visible vapor and flavoring without the need to add the humectants and flavorings directly into the HNB Stick, while the hybrid aerosol generating device can provide increased throat-hit and potency to the user.

Advantageously, the hybrid aerosol generating device allows for accurate electronic tracking of the number of hits and levels of material consumed, both of the e-liquid and the reconstituted or leaf or ground tobacco, allowing for the display of information to the user of nicotine consumption, refill levels etc.

The voltage requirements of the hybrid device may be lower than the sum of an ECIG System and a HNB System combined, due to the increased efficiencies.

In an embodiment, the e-cig pod may be compostable.

In an embodiment, the HNB cigarette may be compostable.

In a further embodiment, multiple ECIG Pods are provided in a single device. Flavors such as mint plus nicotine and mango or strawberry are mixed, for example. Other embodiments include: two ECIG Pods disposed in the same device; two HNB Sticks; or one and one; and other permutations are employed. The devices may be disposed within a housing in side by side or above and below combinations. Multiple or segmented HNB Sticks are useful, as the currently known and available versions must be reloaded after each use.

The non-liquid aerosol-generating material may also be other plant material such as cannabis, hemp, or herbal plant mixes.

The foot or base of the hybrid aerosol generating device may be comprised of silicone or plastic or other known materials and may also function as a charger.

The flow restrictions, wicking speed and heat of the coils may be controlled, advantageously, as by either mechanical valves or electrical valves or by other know means, said valves which may serve to modify or restrict the air entering the hybrid aerosol generating device, or to modify or restrict the air exiting the hybrid aerosol generating device, or to control the mixing of emissions provided by different sources within the hybrid aerosol generating device. Additionally, modifications to the wicking speed may be achieved by modifications to the temperature of the liquid to be wicked, or by using an HNB Cassette system wherein the speed of the reels and the temperature of the heating elements can be adjusted as desired by the user.

In one embodiment, an ECIG Pod can be placed adjacent to an HNB Stick such that a user may place their mouth over both the mouthpiece sections of the ECIG Pod and the HNB Stick at the same time, permitting the user to inhale from both the ECIG Pod and the HNB Stick at the same time. Given that HNB Sticks are usually cylindrical in shape, the ECIG Pod may be shaped in a crescent shape so that any air gap between the two is minimal. Alternately, the ECIG Pod may be toroidal or donut shaped to nest around the HNB Stick. Alternately, the HNB Stick may be non-cylindrical in shape (with one or more flat sides - at the mouthpiece or throughout the HNB Stick) and the mouthpiece of the ECIG Pod may have a matching flat side so as to minimize external airflow between the two.

In one embodiment, a mouthpiece may be affixed over top of the air outlets of both vapor sources such that it draws vapor from both evenly or blended, based on the airflow of the outlets of both vapor sources.

In one embodiment, the mouthpiece may contain a baffle adapted to switch between the two vapor sources. The baffle could allow full and or partial switching between the two sources allowing a user-customized blend between the two vapor sources.

In a further embodiment, this case may be waterproof or made of water-resistant materials.

In another embodiment, the case may provide a battery to extend the usage of the devices inside or to allow a recharging of the internal batteries of the contained devices.

In another embodiment, the case may include a pass-through charging port to allow simultaneous charging of the devices inside the hybrid aerosol generating device.

In another embodiment, the product may itself be a vaporizing device designed to contain two or more sources of vapor production.

In one embodiment, this may include a heat-not-burn warming oven for a tobacco stick as well as electronic contacts to allow for an e-cigarette liquid pod.

In another embodiment, this may include a warming oven for a heat-not-burn tobacco stick and a built-in tank for e-cigarette liquids.

In another embodiment, two or more warming ovens may be present to allow for two or more heat-not-burn tobacco sticks to be warmed at the same time.

In another embodiment, two or more e-cigarette pod contacts (or e-liquid tanks with built-in wick and coil assemblies) may be employed

In a further embodiment, a hybrid device or article for combining at least one independently operable heat-not-burn device, said heat-not-burn device being intended primarily for the creation of inhalable emissions from non-liquid aerosol generating materials, with at least one independently operable electronic cigarette device, said electronic cigarette device being intended primarily for the creation of inhalable emissions from liquid aerosol generating materials, such that the emissions produced by each of the independently operable heat-not-burn device(s) and electronic cigarette device(s) can be inhaled simultaneously by a user, is provided.

In another embodiment, a hybrid device includes one or more mouthpiece(s), and may be capable of electrically connecting to the independently operable and included heat-not-burn device(s) and the at least one independently operable and included electronic cigarette device(s).

A hybrid aerosol generating device comprising a housing, said housing comprising at least one external surface and at least one internal surface, with the internal surface(s) defining at least one cavity in the housing having proximal and distal ends, the at least one cavity having a longitudinal extent between its proximal and distal ends, in which is contained within the at least one cavity is provided.

In one configuration designed to receive at least one HNB Stick smoker's article (said HNB Stick smoker's article comprising at least: a housing, said housing comprising at least one external surface and at least one internal surface, with the internal surface(s) defining at least one cavity in the housing; and, contained or substantially contained within the housing at least one non-liquid aerosol forming material; and, at least one air intake; and, optionally, a mouthpiece for delivering emissions into an adult user's mouth); and, a heater element configured to heat the non-liquid aerosol forming material contained within the HNB Stick smoker's article being received in the cavity; and, optionally, at least one air inlet to the cavity; and contained within the same cavity or contained within at least one additional cavity: a configuration designed to receive (or also receive) an ECIG Pod smoker's article (said ECIG Pod smoker's article comprising at least a housing, said housing comprising at least one external surface and at least one internal surface, with the internal surface(s) defining at least one cavity in the housing, and, contained or substantially contained within the housing: at least one liquid aerosol forming material; and, at least one heater or other aerosol forming apparatus; and, at least one electrical connection capable of electrically connecting to the hybrid aerosol generating device; and, at least one air intake; and, optionally, a mouthpiece for delivering emissions into an adult user's mouth); and, at least one electrical connection within the cavity being capable of electrically connecting to the ECIG Pod smoker's article being received in the cavity (said electrical connections being able to supply power to the ECIG Pod smoker's article such that the ECIG Pod smoker's article can through heating or other means form an emission from the liquid aerosol forming material); and, optionally, at least one air inlet to the cavity; and a power source, such as a rechargeable lithium battery.

The hybrid aerosol generating device may include one or more mouthpiece(s), said mouthpiece(s) serving to concurrently convey the emissions produced by at least two of the smoker's articles into an adult user's mouth.

The hybrid aerosol generating device mouthpiece(s) may contain one or more structures which permit modification to the ratio of emissions produced by at least two of the smoker's articles being concurrently conveyed into an adult user's mouth.

The hybrid aerosol generating device mouthpiece(s) may include one or more vents to permit external air flow to mix with the emissions produced by one or more of the smoker's articles prior to the emissions entering an adult user's mouth.

The hybrid aerosol generating mouthpiece of the ECIG Pod smoker's article may be adapted to abut, encompass, or surround the mouthpiece of the HNB Stick smoker's article.

The hybrid aerosol generating device mouthpiece of the HNB Stick smoker's article may be adapted to abut, encompass, or surround the mouthpiece of the ECIG Pod smoker's article.

The hybrid aerosol generating device mouthpiece section of the HNB Stick smoker's article may be generally cylindrical and wherein at least one side of the mouthpiece section of the ECIG Pod smoker's article is generally crescent shaped.

The hybrid aerosol generating device smoker's article (either the HNB Stick or ECIG Pod) may be positioned substantially inline with at least one other smoker's article, such that the emissions produced by at the first smoker's article are drawn into the air intake of the second smoker's article, whereby the emissions produced by the first smoker's article mix with the emissions produced by the second smoker's article before exiting through the mouthpiece of the second smoker's article and subsequently into an adult user's mouth.

The hybrid aerosol generating device smoker's article may be positioned next to or adjacent to at least one other smoker's article, such that the emissions produced by the first smoker's article are drawn into the housing or mouthpiece of the second smoker's article, whereby the emissions produced by the first smoker's article mix with the emissions produced by the second smoker's article before exiting through the mouthpiece of the second smoker's article and subsequently into an adult user's mouth.

The hybrid aerosol generating device may further comprising a PLC or other control means configured to allow a user to vary the temperatures of the heaters in the hybrid aerosol generating device.

An embodiment of the HNB Multiple Segment smoker's article may comprise: a housing, said housing comprising at least one external surface and at least one internal surface, with the internal surface(s) defining at least one cavity in the housing; and contained within the housing, at least one partition designed to separate the non-liquid aerosol generating material into at least two discrete sections; and at least one air intake which permits air to enter each of the discrete sections; and at least one air outtake which permits air and or emissions to exit each discrete section.

The hybrid aerosol generating device HNB Stick smoker's article may be an HNB Multiple Segment smoker's article.

An embodiment of the HNB reel-to-reel smoker's article may comprise: a housing, said housing comprising at least one external surface and at least one internal surface, with the internal surface(s) defining at least one cavity in the housing; and a length of non-liquid aerosol generating material contained wound onto a first reel; and a second reel configured to receive the length of non-liquid aerosol generating material from the first reel.

An embodiment of the HNB reel-to-reel smoker's article heating element may be operably positioned between the first reel and the second reel such that the heating element is configured to heat the aerosol generating material as it runs between the first reel and the second reel.

An embodiment of the HNB reel-to-reel smoker's article opening in the external surface may be located such that it permits access by an externally-located heating element to the inside of the cavity proximal to the aerosol generating material as it runs between the first reel and the second reel.

An embodiment of the HNB reel-to-reel smoker's article mouthpiece may be fluidly connected to the cavity to permit emissions created from the heating of the aerosol generating material to be drawn from within the cavity into an adult user's mouth.

An embodiment of the reel-to-reel smoker's article may have a first reel and a second reel whereby the non-liquid aerosol generating material is drawn through a tank containing liquid aerosol generating material prior to heating.

An embodiment of the HNB reel-to-reel smoker's article may include an adjustment mechanism configured to allow a user to adjust the rate that the second reel receives the aerosol generating material.

An embodiment of the HNB reel-to-reel smoker's article may comprise a non-liquid aerosol generating material contains perforated holes at its edges, and the first reel and the second reel include small pegs configured to hold the non-liquid aerosol generating material using the perforated holes.

An embodiment of the HNB reel-to-reel smoker's article may include an ECIG Pod smoker's article is also contained within the housing.

An embodiment of the hybrid aerosol generating device may include a HNB Stick smoker's article is an HNB reel-to-reel smoker's article.

What is claimed is:

1. An article for combining at least one independently operable heat-not-burn device, said heat-not-burn device being intended primarily for the creation of inhalable emissions from non-liquid aerosol generating materials, with at least one independently operable electronic cigarette device, said electronic cigarette device being intended primarily for the creation of inhalable emissions from liquid aerosol generating materials, such that the emissions produced by each of the independently operable heat-not-burn device(s) and electronic cigarette device(s) can be inhaled simultaneously by a user.

2. The article of claim 1, wherein the article includes one or more mouthpiece(s).

3. The article of claim 1, wherein the article is capable of electrically connecting to one or more of the at least one independently operable heat-not-burn device(s) and the at least one independently operable electronic cigarette device(s).

4. A hybrid aerosol generating device comprising a housing, said housing comprising at least one external surface and at least one internal surface, with the internal surface(s) defining at least one cavity in the housing having proximal and distal ends, the at least one cavity having a longitudinal extent between its proximal and distal ends, in which is contained within the at least one cavity:
a configuration designed to receive at least one HNB Stick smoker's article (said HNB Stick smoker's article comprising at least: a housing, said housing comprising at least one external surface and at least one internal surface, with the internal surface(s) defining at least one cavity in the housing; and, contained or substantially contained within the housing at least one non-liquid aerosol forming material; and, at least one air intake; and, optionally, a mouthpiece for delivering emissions into an adult user's mouth); and, a heater element configured to heat the non-liquid aerosol forming material contained within the HNB Stick smoker's article being received in the cavity; and, optionally, at least one air inlet to the cavity; and
contained within the same cavity or contained within at least one additional cavity:
a configuration designed to receive (or also receive) an ECIG Pod smoker's article (said ECIG Pod smoker's article comprising at least a housing, said housing comprising at least one external surface and at least one internal surface, with the internal surface(s) defining at least one cavity in the housing, and, contained or substantially contained within the housing: at least one liquid aerosol forming material; and, at least one heater or other aerosol forming apparatus; and, at least one electrical connection capable of electrically connecting to the hybrid aerosol generating device; and, at least one air intake; and, optionally, a mouthpiece for delivering emissions into an adult user's mouth); and, at least one electrical connection within the cavity being capable of electrically connecting to the ECIG Pod smoker's article being received in the cavity (said electrical connections being able to supply power to the ECIG Pod smoker's article such that the ECIG Pod smoker's article can through heating or other means form an emission from the liquid aerosol forming material); and, optionally, at least one air inlet to the cavity; and
a power source, such as a rechargeable lithium battery.

5. The hybrid aerosol generating device of claim 4, wherein the device includes one or more mouthpiece(s), said mouthpiece(s) serving to concurrently convey the emissions produced by at least two of the smoker's articles into an adult user's mouth.

6. The hybrid aerosol generating device of claim 5, wherein the one or more mouthpiece(s) contains one or more structures which permit modification to the ratio of emissions produced by at least two of the smoker's articles being concurrently conveyed into an adult user's mouth.

7. The hybrid aerosol generating device of claim 5, wherein the one or more mouthpiece(s) includes one or more vents to permit external air flow to mix with the emissions produced by one or more of the smoker's articles prior to the emissions entering an adult user's mouth.

8. The hybrid aerosol generating device of claim 4, wherein the mouthpiece of the ECIG Pod smoker's article is adapted to abut, encompass, or surround the mouthpiece of the HNB Stick smoker's article.

9. The hybrid aerosol generating device of claim 4, wherein the mouthpiece of the HNB Stick smoker's article is adapted to abut, encompass, or surround the mouthpiece of the ECIG Pod smoker's article.

10. The hybrid aerosol generating device of claim 8, wherein the mouthpiece section of the HNB Stick smoker's article is generally cylindrical and wherein at least one side of the mouthpiece section of the ECIG Pod smoker's article is generally crescent shaped.

11. The hybrid aerosol generating device of claim 4, wherein at least one smoker's article (either the HNB Stick or ECIG Pod) is positioned substantially inline with at least one other smoker's article, such that the emissions produced by at the first smoker's article are drawn into the air intake of the second smoker's article, whereby the emissions produced by the first smoker's article mix with the emissions produced by the second smoker's article before exiting through the mouthpiece of the second smoker's article and subsequently into an adult user's mouth.

12. The hybrid aerosol generating device of claim 4, wherein at least one smoker's article is positioned next to or adjacent to at least one other smoker's article, such that the emissions produced by the first smoker's article are drawn into the housing or mouthpiece of the second smoker's article, whereby the emissions produced by the first smoker's article mix with the emissions produced by the second smoker's article before exiting through the mouthpiece of the second smoker's article and subsequently into an adult user's mouth.

13. The hybrid aerosol generating device of claim 4, further comprising a PLC or other control means configured to allow a user to vary the temperatures of the heaters in the hybrid aerosol generating device.

14. A HNB Multiple Segment smoker's article comprising:
a housing, said housing comprising at least one external surface and at least one internal surface, with the internal surface(s) defining at least one cavity in the housing; and
contained within the housing, at least one partition designed to separate the non-liquid aerosol generating material into at least two discrete sections; and
at least one air intake which permits air to enter at least one of the discrete sections; and
at least one air outlet which permits air and or emissions to exit at least one of the discrete sections.

15. The hybrid aerosol generating device of claim 4, wherein the HNB Stick smoker's article is an HNB Multiple Segment smoker's article.

16. An HNB reel-to-reel smoker's article comprising:
a housing, said housing comprising at least one external surface and at least one internal surface, with the internal surface(s) defining at least one cavity in the housing;
and a length of non-liquid aerosol generating material contained wound onto a first reel; and
a second reel configured to receive the length of non-liquid aerosol generating material from the first reel.

17. The HNB reel-to-reel smoker's article of claim 16, wherein a heating element is operably positioned between the first reel and the second reel such that the heating element is configured to heat the aerosol generating material as it runs between the first reel and the second reel.

18. The HNB reel-to-reel smoker's article of claim 16, wherein at least one opening in the external surface is located such that it permits access by an externally-located heating element to the inside of the cavity proximal to the aerosol generating material as it runs between the first reel and the second reel.

19. The HNB reel-to-reel smoker's article of claim 16, wherein at least one mouthpiece is fluidly connected to the cavity to permit emissions created from the heating of the aerosol generating material to be drawn from within the cavity into an adult user's mouth.

20. The HNB reel-to-reel smoker's article of claim 16, wherein between the first reel and the second reel the non-liquid aerosol generating material is drawn through a tank containing liquid aerosol generating material prior to heating.

21. The HNB reel-to-reel smoker's article of claim 16, further comprising an adjustment mechanism configured to allow a user to adjust the rate that the second reel receives the aerosol generating material.

22. The HNB reel-to-reel smoker's article of claim 16, wherein the non-liquid aerosol generating material contains perforated holes at its edges, and the first reel and the second reel include small pegs configured to hold the non-liquid aerosol generating material using the perforated holes.

23. The HNB reel-to-reel smoker's article of claim 16, wherein an ECIG Pod smoker's article is also contained within the housing.

24. The hybrid aerosol generating device of claim 4, wherein the HNB Stick smoker's article is an HNB reel-to-reel smoker's article.

25. The article of claim 1, wherein the article is one or more mechanical feature(s), such as clip(s), magnet(s), or other feature(s), which are integrally constructed into or onto or within the housing of either the heat-not-burn device or the electronic cigarette device or both, said feature(s) intended to permit the removable joining of a heat-not-burn device to an electronic cigarette device.
